(19) United States
(12) Patent Application Publication
(10) Pub. No.: US 2014/0298801 A1
(43) Pub. Date: Oct. 9, 2014

(54) EXHAUST GAS RECIRCULATION APPARATUS FOR ENGINE

(71) Applicant: AISAN KOGYO KABUSHIKI KAISHA, Obu-shi (JP)

(72) Inventors: Minoru AKITA, Ama-shi (JP); Mamoru YOSHIOKA, Nagoya-shi (JP)

(21) Appl. No.: 14/230,304

(22) Filed: Mar. 31, 2014

(30) Foreign Application Priority Data
Apr. 5, 2013 (JP) 2013-079450

(51) Int. Cl. F02M 25/07

(52) U.S. Cl. CPC F02M 25/077
USPC 60/602

(57) ABSTRACT

An EGR apparatus includes an EGR passage to allow part of exhaust gas discharged from a combustion chamber to flow as EGR gas into an intake passage and recirculate back to the combustion chamber, and an EGR valve to regulate the EGR gas in the EGR passage. A control unit is arranged to calculate a target opening degree of the EGR valve according to an operating condition after start-up of an engine and a warm-up state of the engine comes to an operation start state of the EGR valve, and correct the calculated target opening degree according to the warm-up state to control the EGR valve based on the corrected target opening degree during a period from when the EGR valve comes to the operation start state to when warm-up of the EGR valve is completed.

### CROSS-REFERENCE TO RELATED APPLICATIONS

This application is based upon and claims the benefit of priority from the prior Japanese Patent Application No. 2013-079450 filed on Apr. 5, 2013, the entire contents of which are incorporated herein by reference.

### BACKGROUND OF THE INVENTION

1. Field of the Invention

The present invention relates to an exhaust gas recirculation apparatus for an engine to allow part of exhaust gas discharged from an engine to an exhaust passage to flow in an intake passage to recirculate back to the engine.

2. Related Art

Conventionally, a technique of the above type is employed in a vehicle engine, for example. An exhaust gas recirculation (EGR) apparatus is arranged to introduce part of exhaust gas after combustion, which is discharged from a combustion chamber of an engine to an exhaust passage, into an intake passage as EGR gas through an EGR passage so that the exhaust gas is mixed with intake air flowing in the intake passage and flows back to the combustion chamber. The EGR gas flowing in the EGR passage is regulated by an EGR valve provided in the EGR passage. This EGR can reduce mainly nitrogen oxide (NOx) in the exhaust gas and improve fuel consumption during a partial load operation of the engine.

Exhaust gas from the engine contains no oxygen or is in an oxygen lean state. Thus, when part of the exhaust gas is mixed with the intake air by EGR, the oxygen concentration of the intake air decreases. In a combustion chamber, therefore, fuel burns in a low oxygen concentration. Thus, a peak temperature during combustion decreases, thereby restraining the occurrence of NOx. In a gasoline engine, even when the content of oxygen in intake air is not increased by EGR and a throttle valve is closed to some degree, it is possible to reduce pumping loss of the engine.

Herein, recently, it is conceivable to perform EGR in the entire operating region of the engine in order to further improve fuel consumption. Realization of high EGR is thus demanded. To realize the high EGR, it is necessary for conventional arts to increase the internal diameter of an EGR passage or increase the opening area of a flow passage provided by a valve element and a valve seat of an EGR valve.

JP-A-2(1990)-298656 discloses one example of an EGR apparatus for an engine. Herein, the combustibility of air-fuel mixture in a combustion chamber of an engine may change under the influence of the cooling water temperature (reflecting an engine warm-up state) of the engine and the external temperature. In this EGR apparatus, therefore, a controller is arranged to control operations of an EGR valve in response to the cooling water temperature of the engine and the external temperature. To be specific, the controller is configured to disable operations of the EGR valve, that is, inhibit EGR, when the engine cooling water temperature is a predetermined set value or less, and configured to operate the EGR valve, that is, start EGR, when the cooling water temperature exceeds the set value. The controller is also arranged to set the set value related to the cooling water temperature to a higher value as the external temperature is lower. In this way, the cooling water temperature at which EGR is to be started is changed according to the external temperature so that EGR is performed at appropriate times to improve exhaust emission under circumstances that are likely to generate nitrogen oxide.

### SUMMARY OF INVENTION

### Problems to be Solved by the Invention

Meanwhile, when an EGR valve is controlled to a predetermined target opening degree, an actual opening degree of this EGR valve may change according to a warm-up state of the EGR valve after engine start-up. In vehicles, there may be a change in warm-up state of an EGR valve according to a warm-up state of an engine. The EGR apparatus disclosed in JP-A-2(1990)298656 might cause an error in the actual opening degree of the EGR valve when the EGR valve is controlled to the predetermined target opening degree, resulting in an error in a flow rate of EGR gas flowing through an EGR passage.

Specifically, even when the EGR valve is controlled to the same target opening degree, the actual opening degree differs by difference in warm-up state between at the time right after the EGR valve starts to operate after engine start-up (when warm-up of the EGR valve is not completed yet) and at the time when warm-up of the EGR valve is completed. This causes an error in the EGR gas flow rate. This is because when warm-up of the EGR valve is completed, components of the EGR valve thermally expand, resulting in a displacement of a valve element with respect to a valve seat. Accordingly, during a period from the start of operation of the EGR valve to the completion of warm-up thereof, an error in the actual opening degree of the EGR valve causes an error in the EGR gas flow rate allowed to recirculate to the combustion chamber. This may deteriorate exhaust emission and driveability of the engine. This error in the EGR gas flow rate is conceived to more notably occur in an EGR apparatus configured to treat high EGR.

FIG. 9 shows a time chart of behaviors of EGR ON/OFF, cooling water temperature of an engine, clearance between a valve element with respect and a valve seat of the EGR valve, and EGR valve opening degree before and after engine start-up. When an engine starts up at time t1, the cooling water temperature of the engine starts to increase as shown in FIG. 9(b), the warm-up of the EGR valve starts accordingly, and the clearance of the valve element starts to decrease as shown in FIG. 9(c). At time t2, thereafter, when the cooling water temperature reaches “70° C.” as shown in FIG. 9(b), which is a reference to enable start of operation of the EGR valve, EGR is turned ON as shown in FIG. 9(a), and the EGR valve is opened at a predetermined target opening degree determined on the assumption of a room temperature as shown in FIG. 9(d). Then, when the cooling water temperature continues to increase as shown in FIG. 9(b) and stops increasing at time t3, engine warm-up is completed. In contrast, warm-up of the EGR valve progresses or advances later than engine warm-up of the engine and thus the clearance of the valve element continues to decrease even after a lapse of time t3 as shown in FIG. 9(c) and stops decreasing at time t4 and the warm-up of the EGR valve is completed. Herein, as indicated by a solid line in FIG. 9(d), the target opening degree of the EGR valve is maintained at a predetermined value at and after time t2, whereas the clearance of the valve element decreases during a period until the warm-up of the EGR valve is completed as shown in FIG. 9(c). As indicated by a broken line in FIG. 9(d), the actual opening degree of the EGR valve continues to decrease until time t4 and then be constant. At the appropriate time when the warm-up of the engine and the warm-up of the EGR valve are both completed, that is, at time t5, the actual opening degree after completion of warm-up is displaced from the target opening degree at room temperature as shown in FIG. 9(d) and thus an error occurs in an EGR gas flow rate regulated by the EGR valve. In particular, during a period from when the operation of the EGR valve is allowed to start (the cooling water temperature is 70° C.) to when the warm-up of the EGR valve is completed, that is, between time t2 and time t4, an error in the opening degree of the EGR valve changes with time and an error in the EGR gas flow rate also changes with time.

The present invention has been made in view of the circumstances and has a purpose to provide an exhaust gas recirculation apparatus for engine, configured to enable controlling an exhaust gas recirculation valve at an appropriate opening degree according to a warm-up state of the exhaust gas recirculation valve after engine start-up to address displacement of an actual opening degree due to thermal expansion of components constituting the exhaust gas recirculation valve.

### Means of Solving the Problems

To achieve the above purpose, one aspect of the invention provides an exhaust gas recirculation apparatus for an engine, the apparatus including: an exhaust gas recirculation passage to allow part of exhaust gas discharged from a combustion chamber of an engine to an exhaust passage to flow as exhaust recirculation gas into an intake passage and recirculate back to the combustion chamber; an exhaust gas recirculation valve provided in the exhaust gas recirculation passage to regulate a flow rate of the exhaust recirculation gas in the exhaust gas recirculation passage, an operating condition detection unit configured to detect an operating condition of the engine including a warm-up state of the engine; a control unit configured to control the exhaust gas recirculation valve according to the detected operating condition, wherein the control unit is arranged to calculate a target opening degree of the exhaust gas recirculation valve according to the detected operating condition after start-up of the engine and correct the calculated target opening degree according to the detected warm-up state to control the exhaust gas recirculation valve based on the corrected target opening degree.

### Advantageous Effects of Invention

According to the present invention, it is possible to control an exhaust gas recirculation valve at an appropriate opening degree according to a warm-up state of the exhaust gas recirculation valve after engine start-up to address a displacement of an actual opening degree due to thermal expansion of components of the exhaust gas recirculation valve.

### BRIEF DESCRIPTION OF THE DRAWINGS

FIG. 1 is a schematic configuration view showing a supercharger-equipped engine system including an exhaust gas recirculation (EGR) apparatus for an engine in an embodiment;

FIG. 2 is a cross sectional view showing a schematic configuration of an EGR valve in the embodiment;

FIG. 3 is an enlarged cross sectional view showing a valve seat and a valve element of the EGR valve in the embodiment;

FIG. 4 is a flowchart showing one example of processing details of EGR control in the embodiment;

FIG. 5 is a flowchart showing one example of processing details to separately calculate a correction value of a target opening degree in relation to the EGR control in the embodiment;

FIG. 6 is a map to obtain an initial correction value according to cooling water temperature in the embodiment;

FIG. 7 is a time chart showing behaviors of various parameters related to EGR control and others in the embodiment;

FIG. 8 is a schematic configuration view showing a supercharger-equipped engine system including an EGR apparatus for an engine in another embodiment; and

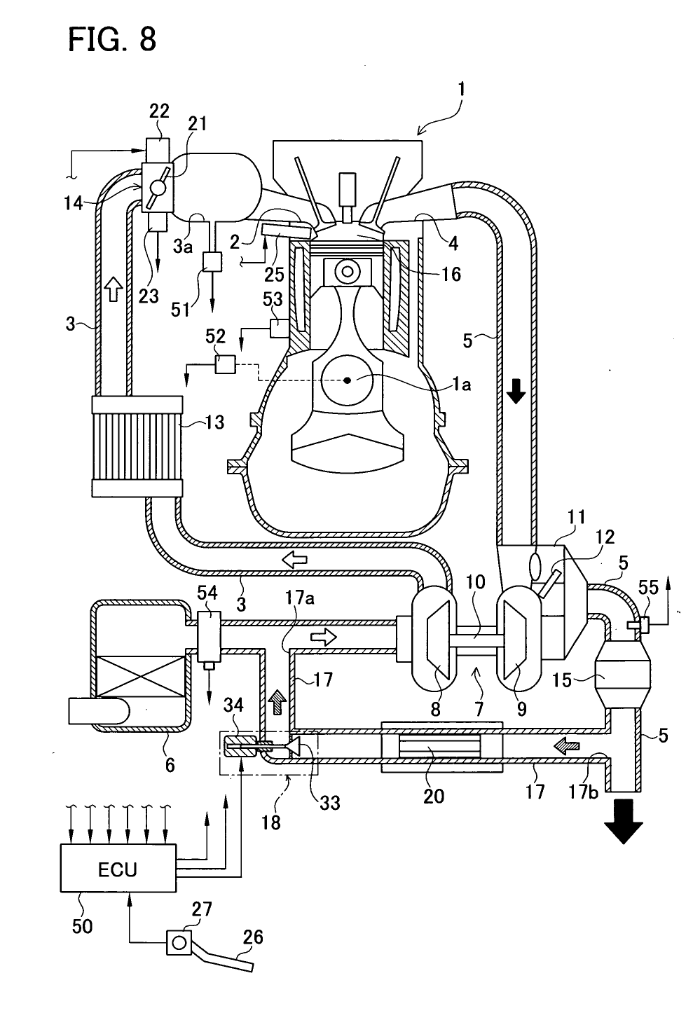

FIG. 9 is a time chart showing behaviors of various parameters related to EGR control and others in a conventional example.

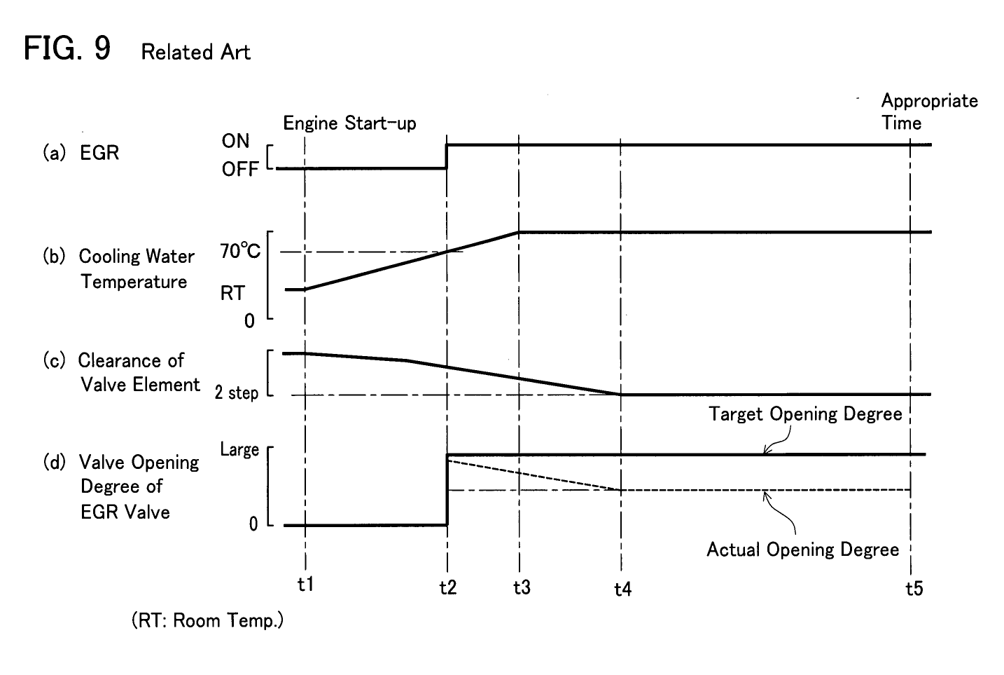

### DESCRIPTION OF EMBODIMENTS

A detailed description of a preferred embodiment of an exhaust gas recirculation apparatus for an engine embodying the present invention will now be given referring to the accompanying drawings.

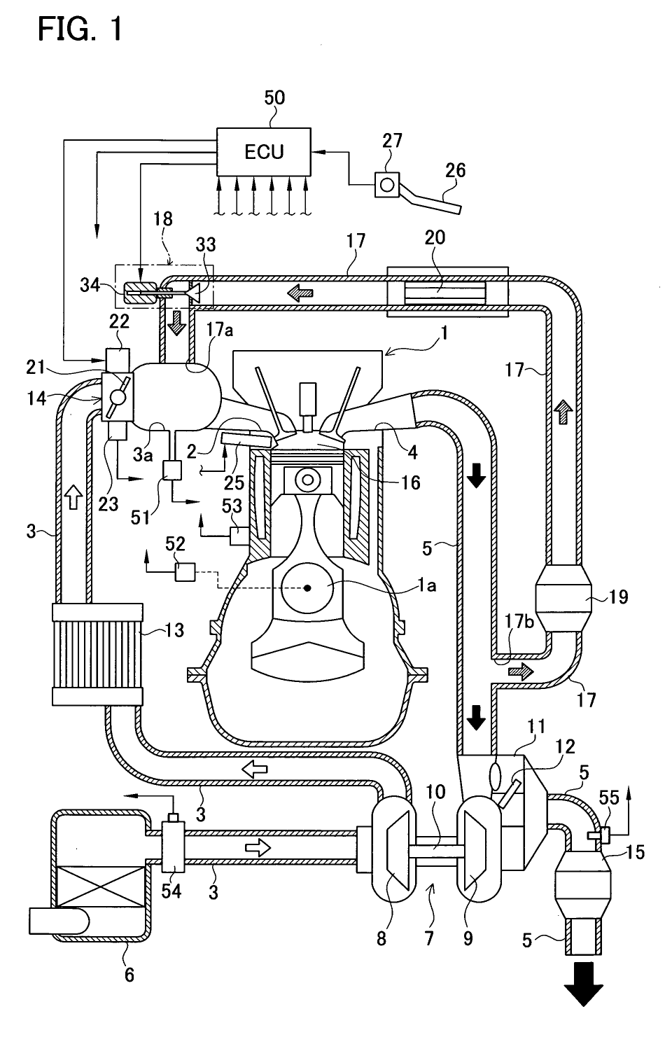

FIG. 1 is a schematic configuration view showing a supercharger-equipped engine system including an exhaust gas recirculation (EGR) apparatus for an engine in the present embodiment. This engine system includes a reciprocating-type engine 1. This engine 1 has an intake port 2 connected to an intake passage 3 and an exhaust port 4 connected to an exhaust passage 5. An air cleaner 6 is provided at an inlet of the intake passage 3. In the intake passage 3 downstream from the air cleaner 6, a supercharger 7 is placed in a position between a portion of the intake passage 3 and a portion of the exhaust passage 5 to increase the pressure of intake air in the intake passage 3.

The supercharger 7 includes a compressor 8 placed in the intake passage 3, a turbine 9 placed in the exhaust passage 5, and a rotary shaft 10 connecting the compressor 8 and the turbine 9 so that they are integrally rotatable. The supercharger 7 is configured to rotate the turbine 9 with exhaust gas flowing in the exhaust passage 5 and integrally rotate the compressor 8 through the rotary shaft 10 in order to increase the pressure of intake air in the intake passage 3, that is, carry out supercharging.

In the exhaust passage 5, adjacent to the supercharger 7, an exhaust bypass passage 11 is provided by detouring around the turbine 9. In this exhaust bypass passage 11, a waste gate valve 12 is placed. This waste gate valve 12 regulates exhaust gas allowed to flow in the exhaust bypass passage 11. Thus, a flow rate of exhaust gas to be supplied to the turbine 9 is regulated, thereby controlling the rotary speeds of the turbine 9 and the compressor 8, and adjusting supercharging pressure of the supercharger 7.

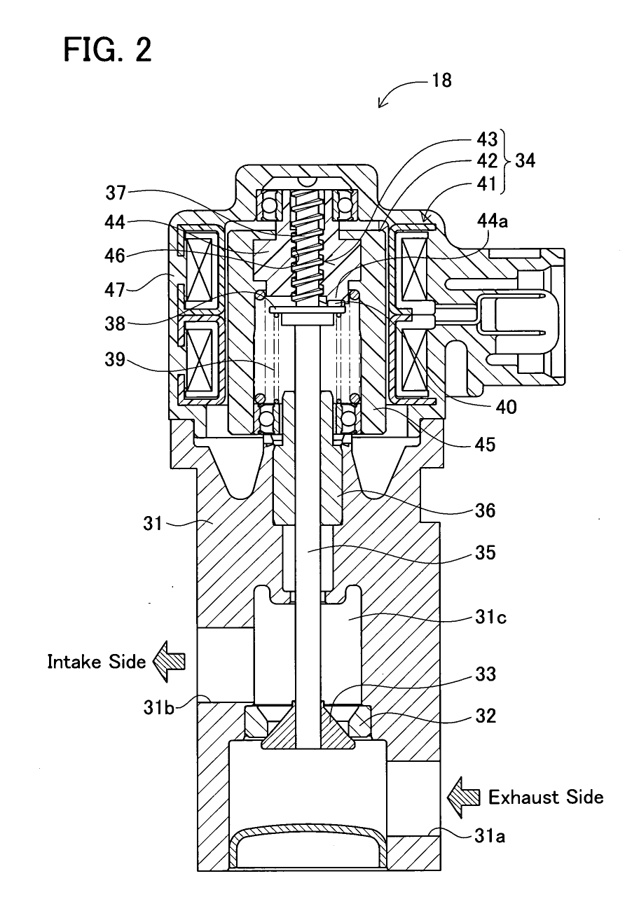

In the intake passage 3, an intercooler 13 is provided between the compressor 8 of the supercharger 7 and the engine 1. This intercooler 13 serves to cool intake air having the pressure increased by the compressor 8 and hence a high temperature, down to an appropriate temperature. A surge tank 3a is provided in the intake passage 3 between the intercooler 13 and the engine 1. Further, an electronic throttle device 14 that is an electrically-operated throttle valve is placed downstream from the intercooler 13 but upstream from the surge tank 3a. This throttle device 14 includes a butterfly-shaped throttle valve 21 placed in the intake passage 3, a DC motor 22 to drive the throttle valve 21 to open and close, and a throttle sensor 23 to detect an opening degree or position (a throttle opening degree) TA of the throttle valve 21. This throttle device 14 is configured so that the throttle valve 21 is driven by the DC motor 22 to open and close according to operation of an accelerator pedal 26 by a driver to adjust the opening degree. The configuration of this throttle device 14 can be provided by for example a basic configuration of a “throttle device” disclosed in JP-A-2011-252482, FIGS. 1 and 2. In the exhaust passage 5 downstream from the turbine 9, a catalytic converter 15 is provided as an exhaust catalyst to clean exhaust gas.

The engine 1 is further provided with an injector 25 to inject and supply fuel into a combustion chamber 16. The injector 25 is configured to be supplied with the fuel from a fuel tank (not shown).

In the present embodiment, the EGR apparatus to enable high EGR includes an exhaust gas recirculation (EGR) passage 17 allowing part of exhaust gas discharged from the combustion chamber 16 of the engine 1 to the exhaust passage 5 to flow in the intake passage 3 as EGR gas and recirculate back to the combustion chamber 16, and an exhaust gas recirculation (EGR) valve 18 placed in the EGR passage 17 to regulate an exhaust gas flow rate (EGR flow rate) in the EGR passage 17. The EGR passage 17 is provided to extend between the exhaust passage 5 upstream from the turbine 9 and the surge tank 3a. Specifically, an outlet 17a of the EGR passage 17 is connected to the surge tank 3a on a downstream side from the throttle valve 21 in order to allow a part of exhaust gas flowing in the exhaust passage 5 to flow as EGR gas into the intake passage 3 and recirculate to the combustion chamber 16. An inlet 17b of the EGR passage 17 is connected to the exhaust passage 5 upstream from the turbine 9.

In the vicinity of the inlet 17b of the EGR passage 17, an EGR catalytic converter 19 is provided to clean EGR gas. In the EGR passage 17 downstream from this EGR catalytic converter 19, an EGR cooler 20 is provided to cool EGR gas flowing in the EGR passage 17. In the present embodiment, the EGR valve 18 is located in the EGR passage 17 downstream from the EGR cooler 20.

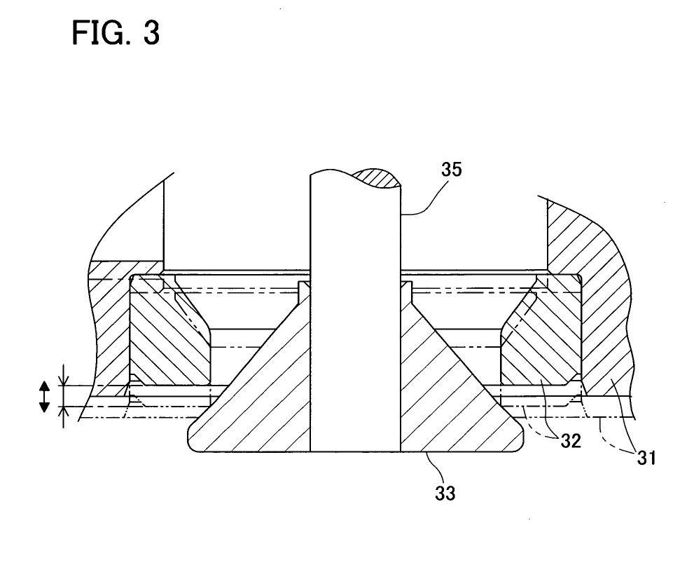

FIG. 2 is a cross sectional view showing a schematic configuration of the EGR valve 18. FIG. 3 is an enlarged cross sectional view showing a valve seat 32 and a valve element 33 in the EGR valve 18. As shown in FIG. 2, the EGR valve 18 is configured as a poppet valve and a motor-operated valve. Specifically, the EGR valve 18 is provided with a housing 31, a valve seat 32 provided in the housing 31, a valve element 33 configured to seat on and move away from the valve seat 32 inside the housing 31, and a step motor 34 to perform stroke movement of the valve element 33. The housing 31 includes an inlet 31a through which EGR gas flows from the side of the exhaust passage 5 (an exhaust side), an outlet 31b through which exhaust gas flows to the side of the intake passage 3 (an intake side), and a communication passage 31c providing communication between the inlet 31a and the outlet 31b. The valve seat 32 is provided at a midpoint of the communication passage 31c.

The step motor 34 includes an output shaft 35 arranged to reciprocate in a straight line (stroke movement). The valve element 33 is fixed at a leading end of the output shaft 35. This output shaft 35 is supported to be able to perform stroke movement through a bearing 36 provided in the housing 31. The output shaft 35 is formed, in its upper part, with a male screw section 37. The output shaft 35 is further formed, in its middle part (near a lower end of the male screw section 37), with a spring retainer 38. This spring retainer 38 has a lower surface serving as a rest for holding a compression spring 39 and an upper surface formed with a stopper 40.

The valve element 33 has a conical shape and is configured to come into or out of contact with the valve seat 32. The valve element 33 is urged toward the step motor 34 by the compression spring 39 placed between the spring retainer 38 and the housing 31, that is, in a valve closing direction to seat on the valve seat 32. When the valve element 33 is stroke-moved from a closed state by the output shaft 35 of the step motor 34 against the urging force of the compression spring 39, the valve element 33 is moved away from the valve seat 32 to a valve open state. For valve opening, specifically, the valve element 33 is moved toward the upstream side (exhaust side) of the EGR passage 17. As above, the EGR valve 18 is configured to open by moving the valve element 33 from the closed state in which the valve element 33 seats on the valve seat 32 toward the upstream side of the EGR passage 17 against the exhaust gas pressure or intake pressure of the engine 1. On the other hand, the valve element 33 is stroke-moved from the open state in the urging direction of the compression spring 39 by the output shaft 35 of the step motor 34, so that the valve element 33 comes near the valve seat 32 and into the closed state. For valve closing, specifically, the valve element 33 is moved toward the downstream side (intake side) of the EGR passage 17.

By stroke-moving the output shaft 35 of the step motor 34, the opening degree of the valve element 33 is adjusted with respect to the valve seat 32. This output shaft 35 is arranged to be stroke-movable only in a predetermined stroke range from the fully closed state where the valve element 33 seats on the valve seat 32 to the fully opened state where the valve element 33 is most apart from the valve seat 32. To achieve high EGR, in the present embodiment, the area of a passage opening in the valve seat 32 is set larger than that in the conventional art. Accordingly, the valve element 33 is designed to be larger in size than that in the conventional art.

The step motor 34 includes coils 41, a magnet rotor 42, and a converting mechanism 43. The step motor 34 is configured so that the coils 41 are excited or energized by currents to rotate the magnet rotor 42 by a predetermined number of motor steps. By this rotation, the converting mechanism 43 converts the rotational movement of the magnet rotor 42 into the stroke movement of the output shaft 35, thereby stroke-moving the valve element 33.

The magnet rotor 42 includes a rotor body 44 made of resin and a ring-shaped plastic magnet 45. The rotor body 44 is formed, in its center, with a female screw section 46 threadedly engaging with the male screw section 37 of the output shaft 35. When the rotor body 44 is rotated with its female screw section 46 threadedly engaging with the male screw section 37 of the output shaft 35, the rotational movement of the rotor body 44 is converted to stroke movement of the output shaft 35. Herein, the male screw section 37 and the female screw section 46 constitute the aforementioned converting mechanism 43. The rotor body 44 is formed, at its bottom, with a contact portion 44a against which the stopper 40 of the spring retainer 38 abuts. When the EGR valve 18 is fully closed, the end face of the stopper 40 comes into surface contact with the end face of the contact portion 44a, thereby restricting the initial position of the output shaft 35. The above coils 41, magnet rotor 42, converting mechanism 43, and other components are covered by a resin casing 47.

In the present embodiment, the number of motor steps of the step motor 34 is changed in a stepwise manner to minutely adjust the opening degree of the valve element 33 of the EGR valve 18 in stages in a range between full close and full open.

In the present embodiment, for respectively executing fuel injection control, intake amount control, EGR control, and other controls, according to the operating condition of the engine 1, an electronic control unit (ECU) 50 controls the injector 25, the DC motor 22 of the electronic throttle device 14, and the step motor 34 of the EGR valve 18 according to the operating condition of the engine 1. The ECU 50 includes a central processing unit (CPU), various memories that store a predetermined control program and others in advance and that temporarily store calculation results and others of the CPU, and an external input circuit and an external output circuit connected to each of them. The ECU 50 is one example of a control unit of the invention. To the external output circuit, there are connected the injector 25, the DC motor 22, and the step motor 34. To the external input circuit, there are connected the throttle sensor 23 and various sensors 27 and 51-55 which are an example of an operating condition detection unit of the invention to detect the operating condition of the engine 1 and transmit various engine signals to the external input circuit. The ECU 50 is also arranged to output a predetermined command signal to the step motor 34 of the EGR valve 18 in order to control the step motor 34.

The various sensors provided in the present embodiment include, the accelerator sensor 27, the intake pressure sensor 51, the rotation speed sensor 52, the water temperature sensor 53, the air flow meter 54, and the air-fuel ratio sensor 55 as well as the throttle sensor 23. The accelerator sensor 27 detects an accelerator opening degree ACC which is an operation amount of the accelerator pedal 26. This accelerator pedal 26 corresponds to an operating unit to control the operation of the engine 1. The intake pressure sensor 51 detects intake pressure PM in the surge tank 3a. That is, the intake pressure sensor 51 is configured to detect intake pressure PM in the intake passage 3 (the surge tank 3a) downstream from a position in which EGR gas flows in the intake passage 3 from the EGR passage 17. The rotation speed sensor 52 detects the rotation angle (crank angle) of the crank shaft 1a of the engine 1 and also detects changes of the crank angle as the rotation speed (engine rotation speed) NE of the engine 1. The water temperature sensor 53 detects the cooling water temperature THW of the engine 1. The warm-up state of the engine 1 can be ascertained from this cooling water temperature THW. The air flow meter 54 detects a flow amount Ga of intake air flowing in the intake passage 3 directly downstream of the air cleaner 6. The air-fuel ratio sensor 55 is placed in the exhaust passage 5 directly upstream of the catalytic convertor 15 to detect an air-fuel ratio A/F in the exhaust gas.

In the present embodiment, the ECU 50 is configured to control the EGR valve 18 in the whole operating region of the engine 1 to control EGR according to the operating condition of the engine 1. On the other hand, the ECU 50 is arranged to control the EGR valve 18 according to the warm-up state of the engine 1 after start-up of the engine 1. The ECU 50 is also configured to control the EGR valve 18 according to the warm-up state of the EGR valve 18 after completion of the warm-up of the engine 1.

Herein, after start-up of the engine 1, the actual opening degree of the EGR valve 18 when the EGR valve 18 is controlled to the predetermined target opening degree may change by the warm-up state of the EGR valve 18. In an engine system mounted in a vehicle, the warm-up state of the EGR valve 18 can change by the warm-up state of the engine 1. In the EGR valve 18, specifically, components (e.g., the housing 31, the casing 47, etc.) constituting the valve 18 thermally expand. The housing 31 having thermally expanded may cause a displacement of the valve seat 32 with respect to the valve element 33 as indicated by a solid line and a two-dot chain line in FIG. 3. Thus, when the EGR valve 18 is controlled at the predetermined target opening degree, an error may occur in the flow rate of EGR gas allowed to flow through the EGR passage 17. In this present embodiment, accordingly, the ECU 50 executes the following EGR control to solve the error in EGR gas flow rate according to the warm-up state of the EGR valve 18.

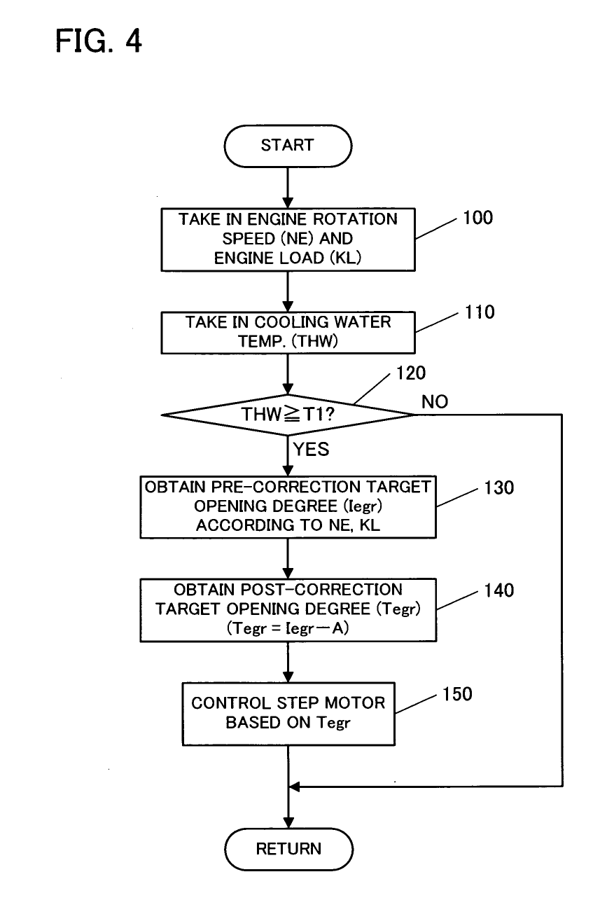

FIG. 4 is a flowchart showing one example of the processing details of the EGR control to be executed by the ECU 50. When the step advances this routine, in step 100, the ECU 50 takes in an engine rotation speed NE and an engine load KL. Herein, the ECU 50 can determine the engine load KL from for example a relationship between the engine rotation speed NE and an intake pressure PM.

In step 110, the ECU 50 takes in a cooling water temperature THW of the engine 1. In step 120, the ECU 50 determines whether or not the cooling water temperature THW is equal to or more than a predetermined value T1, that is, whether or not the warm-up state of the engine 1 is an operation start state that allows or enables the operation of the EGR valve 18 to be started. Herein, the predetermined value T1 can be assigned with for example “70° C.”. If this determination result is negative, the ECU 50 returns the processing to step 100. If this determination result is affirmative, the ECU 50 shifts the processing to step 130.

In step 130, the ECU 50 calculates a pre-correction (before correction) target opening degree Iegr according to the engine rotation speed NE and the engine load KL for the EGR valve 18. The ECU 50 can determine this pre-correction target opening degree Iegr by referring to a predetermined map.

In step 140, the ECU 50 then calculates a post-correction (after correction) target opening degree Tegr for the EGR valve 18. Specifically, the ECU 50 obtains the post-correction target opening degree Tegr by subtracting a warm-up correction value A from the pre-correction target opening degree Iegr. Herein, the ECU 50 takes in the warm-up correction value A separately calculated.

In step 150, the ECU 50 controls the step motor 34 based on the target opening degree Tegr to control the EGR valve 18. Then, the ECU 50 returns the processing to step 100.

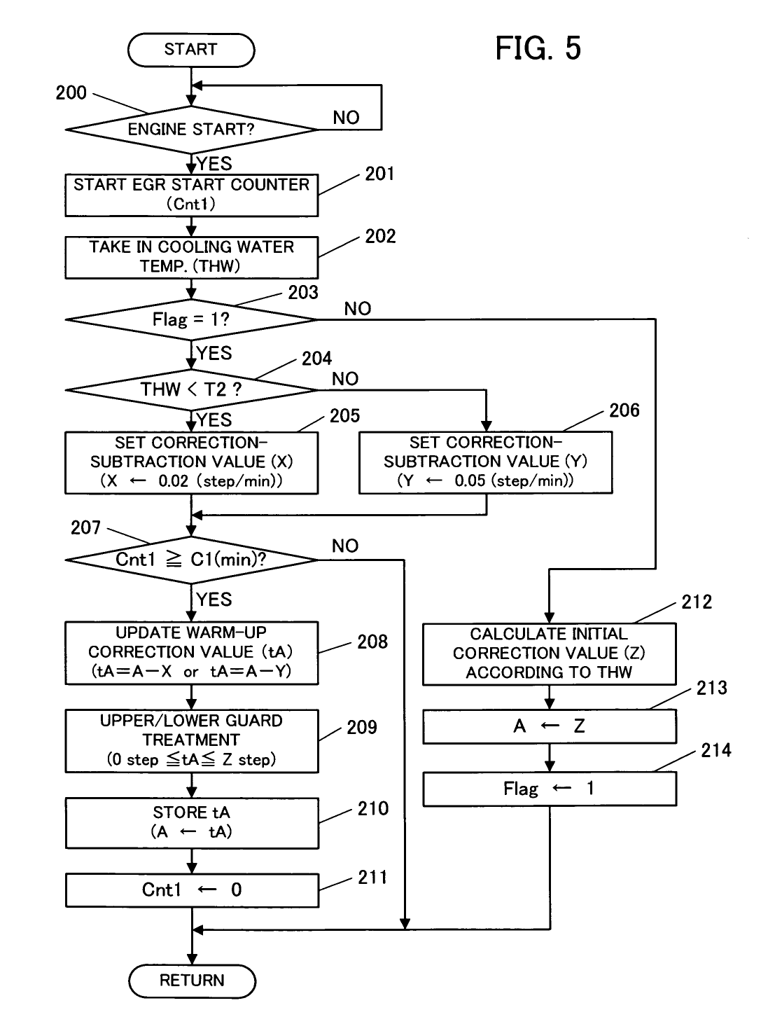

FIG. 5 is a flowchart showing one example of the processing details to calculate the warm-up correction value A in relation to the above EGR control. When the processing shifts to this routine, the ECU 50 waits for start-up of the engine 1 in step 200, and then advances the processing to step 201.

In step 201, the ECU 50 starts an EGR start counter Cnt1, that is, starts to increment a count.

In step 202, the ECU 50 takes in the cooling water temperature THW. This cooling water temperature THW reflects the warm-up state of the engine 1.

In step 203, the ECU 50 determines whether or not an initial determination flag Flag is “1”. As described later, this initial determination flag Flag is set to “1” when an initial correction value Z for the pre-correction target opening degree Iegr is determined (calculated). If this determination result is negative, the ECU 50 shifts the processing to step 212. If this determination result is affirmative, the ECU 50 shifts the processing to step 204.

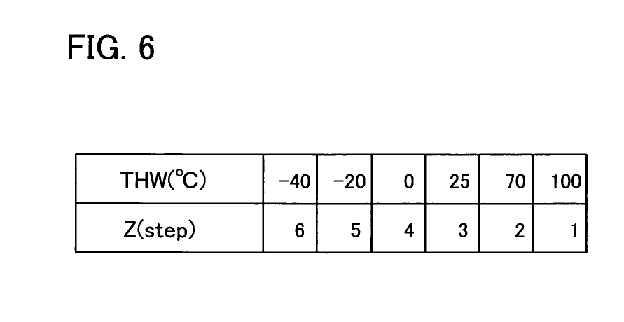

In step 212, the ECU 50 calculates an initial correction value Z according to the cooling water temperature THW. Herein, the ECU 50 can calculate this initial correction value Z by referring to a map shown in FIG. 6. In this map, the initial correction value Z is set to be “1” for “100° C.” of the cooling water temperature THW and be larger, “2, 3, 4, 5, 6” as the cooling water temperature THW is sequentially lower, “70° C., 25° C., 0° C., −20° C., −40° C.”. The initial correction value Z is set in terms of the number of motor steps of the step motor 34.

In step 213, the ECU 50 successively sets (stores) the initial correction value Z as the warm-up correction value A. In step 214, the ECU 50 sets the initial determination flag Flag to “1” and then returns the processing to step 200.

On the other hand, in step 204 following step 203, the ECU 50 determines whether or not the cooling water temperature THW is lower than a predetermined value T2. Herein, the predetermined value T2 can be assigned with for example “85° C.” at which the warm-up of the engine 1 is nearly completed.

If the determination result in step 204 is affirmative, the ECU 50 sets a correction-subtraction value X in step 205. Herein, the correction-subtraction value X can be set to e.g. “0.02 (step/min)”. If the determination result in step 204 is negative, the ECU 50 sets a correction-subtraction value Y in step 206. Herein, the correction-subtraction value Y can be set to e.g. “0.05 (step/min)”.

In step 205 or step 207 following step 206, the ECU 50 determines whether or not the EGR start counter Cnt1 is equal to or more than a predetermined C1 (min). This predetermined value C1 can be assigned with for example “1 (min)”. If this determination result is affirmative, the ECU 50 shifts the processing to step 208. If this determination result is negative, the ECU 50 returns the processing to step 200.

In step 208, the ECU 50 updates an update value tA of the warm-up correction value A. Specifically, the ECU 50 calculates the update value tA, which is a new warm-up correction value, by subtracting the correction-subtraction value X or the correction-subtraction value Y from a previous warm-up correction value A.

In step 209, the ECU 50 performs guard processing of upper limit and lower limit. Specifically, the ECU 50 limits the currently updated update value tA in a range from a lower limit (0 step) or more to an upper limit (Z steps) or less.

In step 210, the ECU 50 stores the current update value tA in a memory. That is, the ECU 50 sets the current update value tA as the warm-up correction value A.

In step 211, the ECU 50 resets the EGR start counter Cnt1 to “0” in step 211 and thereafter returns the processing to step 200.

According to the above control, the ECU 50 calculates the pre-correction target opening degree Iegr of the EGR valve 18 according to the engine rotation speed NE and the engine load KL detected after start-up of the engine 1 and also corrects the pre-correction target opening degree Iegr according to the detected cooling water temperature THW to calculate the post-correction target opening degree Tegr. The ECU 50 then controls the EGR valve 18 based on the post-correction target opening degree Tegr.

To be specific, the ECU 50 calculates the post-correction target opening degree Tegr by correcting the pre-correction target opening degree Iegr according to the cooling water temperature THW during a period from when the detected cooling water temperature THW becomes a predetermined value T1 (when the EGR valve 18 comes to an operation start state) to when the warm-up of the EGR valve 18 is completed. Herein, the ECU 50 calculates the initial correction value Z of the pre-correction target opening degree Iegr based on the cooling water temperature THW detected at the time of start-up of operation of the engine 1. The ECU 50 calculates and updates the warm-up correction value A by subtracting the correction-subtraction value X or Y from the calculated initial correction value Z (the warm-up correction value A) every time a unit of time has passed subsequently. When the detected cooling water temperature THW reaches the predetermined value T2, the ECU 50 increases the correction-subtraction value X to the correction-subtraction value Y. The ECU 50 calculates the post-correction target opening degree Tegr by correcting the calculated pre-correction target opening degree Iegr by the updated warm-up correction value A.

Furthermore, the ECU 50 limits the updating of the warm-up correction value A in a range from a predetermined upper limit (Z steps) to a predetermined lower limit (0 step).

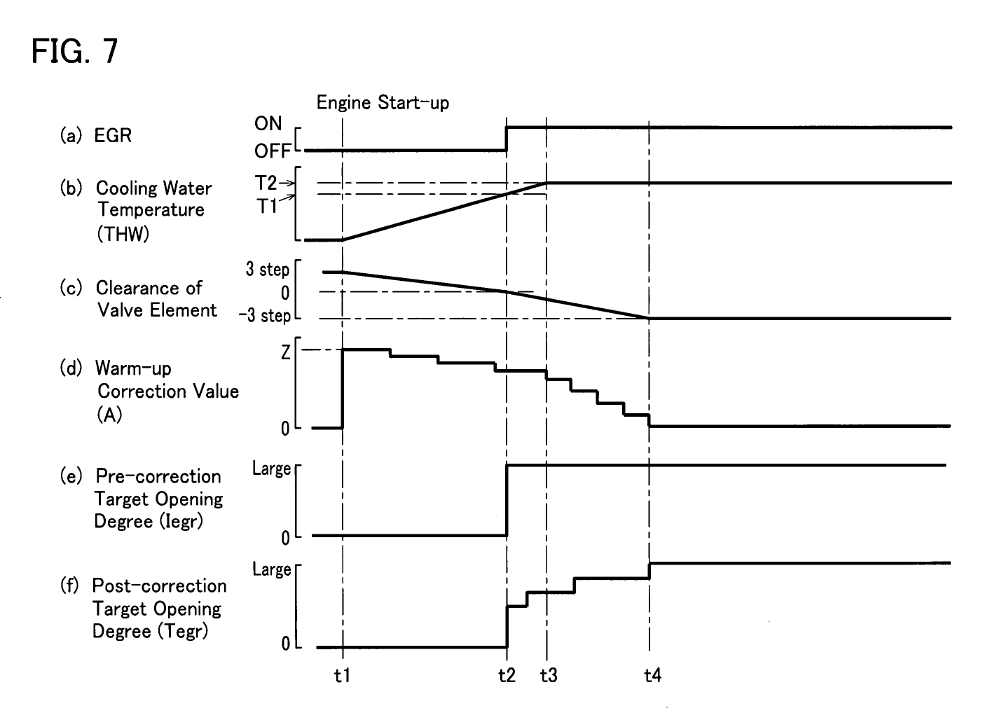

Herein, FIG. 7 is a time chart showing behaviors of various parameters related to the above control. In FIG. 7, when the engine starts up at time t1, the cooling water temperature THW of the engine starts to increase as shown in FIG. 7(b). The warm-up of the EGR valve is started accordingly. The clearance of the valve element starts to decrease as shown in FIG. 7(c). The initial correction value Z is set as the warm-up correction value A as shown in FIG. 7(d). Thereafter, the warm-up correction value A is decreased in stages.

Then, when the cooling water temperature THW reaches the predetermined value T1 (e.g., “70° C.”) at which the operation of the EGR valve 18 is allowed to start as shown in FIG. 7(b), the EGR is turned ON as shown in FIG. 7(a). The pre-correction target opening degree Iegr on the assumption of the room temperature is calculated as a predetermined value as shown in FIG. 7(e). The pre-correction target opening degree Iegr is corrected by subtraction of the warm-up correction value A as shown in FIG. 7(f). Thus, the post-correction target opening degree Tegr is obtained.

When the cooling water temperature THW continues to increase and stops increasing at time t3 as shown in FIG. 7(b), the warm-up of the engine is completed. On the other hand, the warm-up of the EGR valve 18 progresses later than the warm-up of the engine 1. Thus, the clearance of the valve element 33 continues to decrease even beyond time t3 as shown in FIG. 7(c) and then stops decreasing at time t4. Thus, the warm-up of the EGR valve is completed.

As shown in FIG. 7(e), at and after time t2 at which the operation of the EGR valve 18 is allowed to start, the pre-correction target opening degree Iegr of the EGR valve 18 is maintained at the predetermined value. However, the clearance of the valve element 33 is decreased as shown in FIG. 7(c) during a period up to time t4 at which the warm-up of the EGR valve 18 is completed. Accordingly, the actual opening degree of the EGR valve 18 continues to decrease from time t2 to time t4 and thereafter be constant. In contrast, during a period from time t2 to time t4, as shown in FIG. 7(d), the warm-up correction value A is decreased in stepwise fashion as time elapses, thereby stepwise increasing the post-correction target opening degree Tegr with time. At and after time t4 at which the warm-up of the EGR valve 18 is completed, the post-correction target opening degree Tegr becomes equal to the pre-correction target opening degree Iegr. At and after time t4 at which the warm-up of the engine 1 and the warm-up of the EGR valve 18 are completed, therefore, the actual opening degree of the EGR valve 18 almost coincides with the post-correction target opening degree Tegr, so that an error in the EGR gas flow rate to be regulated by the EGR valve 18 is eliminated.

In the configuration of the exhaust gas recirculation for an engine in the present embodiment explained above, after start-up of the engine 1, the actual opening degree of the EGR valve 18 controlled based on the target opening degree by the ECU 50 may change according to the warm-up state of the EGR valve 18. This is because the EGR valve 18 is warmed up by receipt of warm-up heat of the engine 1 and then the components of the EGR valve 18 thermally expand, thereby causing a displacement of the valve element 33 with respect to the valve seat 32. The warm-up state of the EGR valve 18 may also change according to the warm-up state of the engine 1. Therefore, when the EGR valve 18 is controlled based on the target opening degree, the displacement of the actual opening degree may cause an error in the flow rate of EGR gas flowing through the EGR passage 17.

In this respect, according to the present embodiment, after start-up of the engine 1, the ECU 50 calculates the pre-correction target opening degree Iegr of the EGR valve 18 according to the engine rotation speed NE and the engine load KL. The ECU 50 further corrects this pre-correction target opening degree Iegr according to the cooling water temperature THW reflecting the warm-up state of the engine 1 and calculates the post-correction target opening degree Tegr. Based on this post-correction target opening degree Tegr, the ECU 50 controls the EGR valve 18. After start-up of the engine 1, the displacement of the actual opening degree of the EGR valve 18 from the pre-correction target opening degree Iegr is reduced by correction according to the cooling water temperature THW of the engine 1 related to the warm-up state of the EGR valve 18. Therefore, after start-up of the engine 1, the displacement of the actual opening degree resulting from thermal expansion of the components of the EGR valve 18 can be addressed according to the warm-up state of the EGR valve 18 and thus the EGR valve 18 can be controlled at an appropriate opening degree. This can prevent deterioration of exhaust emission and driveability of the engine 1 resulting from the error in the EGR gas flow rate.

In the present embodiment, the warm-up of the EGR valve 18 gradually progresses later than the warm-up of the engine 1. In the configuration of the present embodiment, on this account, the ECU 50 corrects the pre-correction target opening degree Iegr during a period from when the EGR valve 18 comes to an operation start state by the warm-up of the engine 1 (that is, from when the cooling water temperature THW reaches the predetermined value T1) to when the warm-up of the EGR valve 18 is completed. The displacement of the actual opening degree from the pre-correction target opening degree Iegr changing during a period from when the EGR valve 18 comes to the operation start state to when the warm-up of the EGR valve 18 is completed is reduced by correction according to the warm-up state of the engine 1 related to the warm-up state of the EGR valve 18. Especially, during a period from when the EGR valve 18 comes to the operation start state to when the warm-up of the EGR valve 18 is completed, the displacement of the actual opening degree resulting from thermal expansion of the components of the EGR valve 18 can be addressed according to the warm-up state of the EGR valve 18 and thus the EGR valve 18 can be controlled at an appropriate opening degree.

In the present embodiment, the warm-up state of the EGR valve 18 at the start of start-up of the engine 1 is different by the warm-up state of the engine 1 at the start of start-up of the engine 1. In this respect, according to the present embodiment, the ECU 50 calculates the initial correction value Z based on the cooling water temperature THW of the engine 1 detected at the start of start-up of the engine 1. This initial correction value Z is updated by the ECU 50 by subtracting therefrom the correction-subtraction value X or Y every time a unit of time has passed subsequently to obtain the warm-up correction value A. The ECU 50 then corrects the calculated pre-correction target opening degree Iegr by the updated warm-up correction value A. Accordingly, the initial correction value Z is determined first according to the difference in the warm-up state of the engine 1 at the start of start-up of the engine 1. The initial correction value Z is gradually reduced and updated according to changes in the warm-up state of the engine 1, thereby calculating the warm-up correction value A. Thus, the pre-correction target opening degree Iegr is gradually reduced and corrected by the warm-up correction value A. During a period from when the EGR valve 18 comes to the operation start state to when the warm-up of the EGR valve 18 is completed, especially, the displacement of the actual opening degree resulting from thermal expansion of the components of the EGR valve 18 can be addressed according to the warm-up state of the EGR valve 18 and thus the EGR valve 18 can be controlled at an appropriate opening degree.

In the configuration of the present embodiment, when the warm-up state of the engine 1 reaches a predetermined warm-up state, subsequent warm-up of the EGR valve 18 is more quickly advanced. On this account, according to the present embodiment, when the warm-up state (the cooling water temperature THW) of the engine 1 comes to the predetermined warm-up state (the predetermined value T2), the correction-subtraction value X of the warm-up correction value A is increased to the correction-subtraction value Y. Thus, reduction and correction of the pre-correction target opening degree Iegr by the warm-up correction value A is rapidly advanced. Accordingly, it is possible to appropriately correct the pre-correction target opening degree Iegr from when the warm-up state (the cooling water temperature THW) of the engine 1 comes to the predetermined warm-up state (the predetermined value T2). For instance, at the time of restart of start-up of the engine 1 under high temperatures, in which the warm-up state (the cooling water temperature THW) of the engine 1 is in a relatively high degree state, the completion of warm-up of the EGR valve 18 is accelerated. In this regard, in the present embodiment configured to increase the correction-subtraction value X to the correction-subtraction value Y, the warm-up correction value A can be appropriately changed. With this warm-up correction value A, the pre-correction target opening degree Iegr can be corrected more appropriately.

According to the configuration of the present embodiment, updating of the warm-up correction value A is limited by the ECU 50 in a range from a predetermined upper limit to a predetermined lower limit, so that the warm-up correction value A is less likely to become too large or too small. Therefore, the warm-up correction value A can be defined as an effective magnitude, whereby the pre-correction target opening degree Iegr can be effectively corrected to obtain an appropriate post-correction target opening degree Tegr.

The present invention is not limited to the above embodiments and may be embodied variously in other specific forms without departing from the essential characteristics thereof.

(1) In the above embodiment, as shown in FIG. 1, the outlet 17a of the EGR passage 17 is connected to the surge tank 3a downstream of the throttle valve 21 and the inlet 17b is connected to the exhaust passage 5 upstream of the turbine 9. An alternative may be configured as shown in FIG. 7 such that the inlet 17b of the EGR passage 17 is connected to the exhaust passage 5 downstream of the catalytic convertor 15 and the outlet 17a is connected to the intake passage 3 upstream of the compressor 8. FIG. 7 is a schematic configuration view of a supercharger-equipped engine system including the exhaust gas recirculation (EGR) apparatus for an engine.

(2) The above embodiment embodies the EGR apparatus of the invention as the engine 1 equipped with the supercharger 7. The EGR apparatus of the invention can be embodied as an engine not provided with a supercharger.

(3) In the above embodiment, the step motor 34 is used as an actuator of the EGR valve 18. Besides the step motor, a DC motor may also be used.

### INDUSTRIAL APPLICABILITY

The present invention is utilizable in a gasoline engine or a diesel engine for use in vehicles.

Reference Signs List

| | | | |
|---|---|---|---|
| 1 | Engine | 3 | Intake passage |
| 3a | Surge tank | 5 | Exhaust passage |
| 16 | Combustion chamber | | |
| 17 | EGR passage | | |
| | (Exhaust gas | | |
| | recirculation passage) | | |
| 18 | EGR valve | | |
| | (Exhaust gas | | |
| | recirculation valve) | | |
| 50 | ECU (Control unit) | | |
| 51 | Intake pressure sensor | | |
| | (Operating | | |
| | condition detecting unit) | | |
| 52 | Rotation speed sensor | | |
| | (Operating condition | | |
| | detecting unit) | | |
| 53 | Water temperature sensor | | |
| | (Operating condition | | |
| | detecting unit) | | |
| PM | Intake pressure | NE | Engine rotation speed |
| THW | Cooling water | KL | Engine load |
| | temperature | | |
| T1 | Predetermined value | T2 | Predetermined value |
| Iegr | Pre-correction target | | |
| | opening degree | | |
| Tegr | Post-correction target | | |
| | opening degree | | |
| Z | Initial correction value | A | Warm-up correction value |
| X | Correction | Y | Correction subtraction value |
| | subtraction value | | |

1. An exhaust gas recirculation apparatus for an engine, the apparatus including:
an exhaust gas recirculation passage to allow part of exhaust gas discharged from a combustion chamber of an engine to an exhaust passage to flow as exhaust recirculation gas into an intake passage and recirculate back to the combustion chamber;
an exhaust gas recirculation valve provided in the exhaust gas recirculation passage to regulate a flow rate of the exhaust recirculation gas in the exhaust gas recirculation passage,
an operating condition detection unit configured to detect an operating condition of the engine including a warm-up state of the engine;
a control unit configured to control the exhaust gas recirculation valve according to the detected operating condition,
wherein the control unit is arranged to calculate a target opening degree of the exhaust gas recirculation valve according to the detected operating condition after start-up of the engine and correct the calculated target opening degree according to the detected warm-up state to control the exhaust gas recirculation valve based on the corrected target opening degree.

2. The exhaust gas recirculation apparatus for an engine according to claim 1, wherein the control unit is configured to correct the target opening degree according to the warm-up state during a period from when the detected warm-up state comes to an operation start state that allows operation of the exhaust gas recirculation valve to be started to when warm-up of the exhaust gas recirculation valve is completed.

3. The exhaust gas recirculation apparatus for an engine according to claim 1, wherein the control unit is configured to: calculate a correction value of the target opening degree based on the warm-up state detected at start of start-up of the engine; update the calculated correction value by subtraction of a predetermined subtraction value every time a unit of time has passed subsequently; and correct the calculated target opening degree by the updated correction value.

4. The exhaust gas recirculation apparatus for an engine according to claim 3, wherein the control unit is configured to increase the subtraction value when the detected warm-up state comes to a predetermined warm-up state.

5. The exhaust gas recirculation apparatus for an engine according to claim 3, wherein the control unit is configured to increase the subtraction value when the detected warm-up state comes to an operation start state that allows operation of the exhaust gas recirculation valve to be started.

6. The exhaust gas recirculation apparatus for an engine according to claim 3, wherein the control unit is configured to limit updating of the correction value in a range from a predetermined upper limit to a predetermined lower limit.

7. The exhaust gas recirculation apparatus for an engine according to claim 4, wherein the control unit is configured to limit updating of the correction value in a range from a predetermined upper limit to a predetermined lower limit.

8. The exhaust gas recirculation apparatus for an engine according to claim 5, wherein the control unit is configured to limit updating of the correction value in a range from a predetermined upper limit to a predetermined lower limit.
